(19) United States
(12) Patent Application Publication
(10) Pub. No.: US 2020/0088665 A1
(43) Pub. Date: Mar. 19, 2020

(54) GAS SENSOR DIAGNOSIS DEVICE

(71) Applicant: DENSO CORPORATION, Kariya-city (JP)

(72) Inventors: Kensuke TAKIZAWA, Kariya-city (JP); Toshihiko HARADA, Nisshin-city (JP); Hiroki ICHIKAWA, Kariya-city (JP)

(21) Appl. No.: 16/572,676

(22) Filed: Sep. 17, 2019

(30) Foreign Application Priority Data
Sep. 18, 2018 (JP) 2018-174142

(51) Int. Cl. G01N 25/46; G01N 25/00; G01N 31/22

(52) U.S. Cl. CPC G01N 25/46; G01N 31/223; G01N 25/005

(57) ABSTRACT

In a gas sensor diagnosis device, a temperature change part varies a temperature of a sensor element in an ammonia sensor at a first temperature which is outside of the predetermined activation temperature range. A zero-voltage shift detection part detects whether the mixed potential of the sensor element is not more than a predetermined output threshold value after the temperature change part varies a temperature of the sensor element. A temperature acquisition part detects a zero-voltage shift temperature of the sensor element at which the zero-voltage shift detection part detects that the mixed potential of the sensor element drops below the predetermined output threshold value. The deterioration state detection part detects a deterioration state of the ammonia sensor based on the zero-voltage shift temperature of the sensor element detected by the temperature acquisition part.

### CROSS-REFERENCE TO RELATED APPLICATION

This application is related to and claims priority from Japanese Patent Application No. 2018-174142 filed on Sep. 18, 2018, the contents of which are hereby incorporated by reference.

### TECHNICAL FIELD

The present disclosure relates to gas sensor diagnosis devices performing diagnosis of gas sensors.

### BACKGROUND

An exhaust gas purification system has been known and used so as to purify exhaust gas flowing in an exhaust gas pipe of an internal combustion engine. The exhaust gas purification system uses a Selective Catalytic Reduction system (SCR system) and urea water as a reducing agent. The SCR system is a means of converting nitrogen oxides (NOx) contained in exhaust gas with the aid of a catalyst into diatomic nitrogen (N₂) and water (H₂O). In general, an ammonia sensor is arranged at a downstream side of the SCR system in the exhaust gas pipe. The ammonia sensor is a mixed potential type sensor so as to detect the presence of ammonia remaining in exhaust gas at the downstream side of the SCR system. There is a diagnosis device for detecting an ammonia sensor failure, which detects an impedance between a detection electrode and a reference electrode of the ammonia sensor, and performs the diagnosis of the ammonia sensor on the basis of impedance detection results. In general, such a diagnosis device has a complicated structure because it requires a circuit detecting an alternating current (AC) impedance and a circuit receiving the detection results of the AC impedance.

### SUMMARY

It is desired for the present disclosure to provide a gas sensor diagnosis device of a gas sensor of a mixed potential type. The gas sensor has a sensor element arranged to be exposed to a detection target gas. The sensor element generates and transmits a mixed potential to the gas sensor diagnosis device when the sensor element is heated at an activation temperature within a predetermined activation temperature range.

The gas sensor diagnosis device has a central processing unit which provides a temperature change part, a zero-voltage shift detection part, a temperature acquisition part and a deterioration state detection part. The temperature change part varies a temperature of the sensor element at a first temperature which is outside of the predetermined activation temperature range. The zero-voltage shift detection part detects whether the mixed potential of the sensor element is not more than a predetermined output threshold value after the temperature change part varies the temperature of the sensor element. The temperature acquisition part detects a zero-voltage shift temperature of the sensor element at which the zero-voltage shift detection part detects that the mixed potential of the sensor element is not more than the predetermined output threshold value. For example, the predetermined output threshold value is 5 mV. The deterioration state detection part detects whether the sensor element has been deteriorated on the basis of the zero-voltage shift temperature of the sensor element detected by the temperature acquisition part.

### BRIEF DESCRIPTION OF THE DRAWINGS

A preferred, non-limiting embodiment of the present disclosure will be described by way of example with reference to the accompanying drawings, in which:

FIG. 1 is a view showing a schematic structure of an exhaust gas purification system of an internal combustion engine 10;

FIG. 2 is a view showing a schematic structure of an ammonia sensor 30, which is equipped with a gas sensor diagnosis device according to an exemplary embodiment of the present disclosure, assembled in a second composite sensor 25 arranged at a downstream side of a downstream side SCR catalyst 22 mounted on the exhaust gas purification system shown in FIG. 1;

FIG. 3 is a view showing a schematic structure of a detection electrode in the ammonia sensor 30 assembled in the second composite sensor 25 shown in FIG. 1;

FIG. 4 is a graph showing a relationship between a temperature of a sensor element 31 in the ammonia sensor 30 shown in FIG. 2 and a mixed potential V of the ammonia sensor 30 in the second composite sensor 25 arranged at the downstream side of the downstream side SCR catalyst 22 shown in FIG. 1;

FIG. 5A and FIG. 5B are graphs showing a relationship between a temperature and an absolute value of a mixed potential of an ammonia sensor in an initial state, a slight deterioration state and an advanced deterioration state thereof;

FIG. 6A and FIG. 6B are timing charts showing an oxygen concentration and an ammonia (NH₃) concentration in exhaust gas in a fuel-cut state; and

FIG. 7 is a view showing a flow chart of a deterioration diagnosis process of the ammonia sensor performed by the gas sensor diagnosis device according to the exemplary embodiment of the present disclosure.

### DETAILED DESCRIPTION OF THE PREFERRED EMBODIMENTS

Hereinafter, various embodiments of the present disclosure will be described with reference to the accompanying drawings. In the following description of the various embodiments, like reference characters or numerals designate like or equivalent component parts throughout the several diagrams.

In general, a mixed potential type gas sensor, for example, an ammonia sensor is exposed to a detection target gas such as exhaust gas emitted from an internal combustion engine at a temperature within a predetermined activation temperature range, and the gas sensor outputs a mixed potential. On the other hand, electrochemical reaction in the sensor element reaches its equilibrium state and the mixed potential is not more than a predetermined output threshold value when a sensor element in the gas sensor reaches a temperature which is higher than the predetermined activation temperature range. For example, the predetermined output threshold value is 5 mV, which will be explained later. After performing various types of experiments, the inventors of the present disclosure have found that a zero-voltage shift phenomenon occurs at a temperature higher than that of a normal sensor which is operating correctly, i.e. operating normally, where the mixed potential drops below the predetermined output threshold value at the zero-voltage shift temperature.

Further, even if the sensor element operates at a temperature which is lower than the predetermined activation temperature range, it has been known to occur the zero-voltage shift phenomenon in which the mixed potential of the mixed potential sensor is not more than the predetermined output threshold value (for example, 5 mV).

The inventors of the present disclosure have found that when the sensor element is cooled to a temperature which is outside of the predetermined activation temperature range, the zero-voltage shift temperature becomes higher than that of a normal sensor which is operating normally in a deterioration state in which the sensor has been deteriorated.

Accordingly, it is preferable for the gas sensor diagnosis device to take the temperature of the sensor element outside of the predetermined activation temperature range so as to shift the mixed potential of the sensor element to a value of not more than the predetermined output threshold value, i.e. so that the mixed potential of the sensor element disappears.

The gas sensor diagnosis device detects a zero-voltage shift temperature, which is a temperature when the mixed potential is shifted to zero or to a voltage close to zero, i.e. to a temperature when the mixed potential drops below the predetermined output threshold value, and detects a degree of deterioration of the sensor element on the basis of the detected temperature. Accordingly, it is possible for the gas sensor diagnosis device according to the present disclosure to normally detect a deterioration state of a gas sensor with high accuracy and a simple structure and control operation.

### EXEMPLARY EMBODIMENT

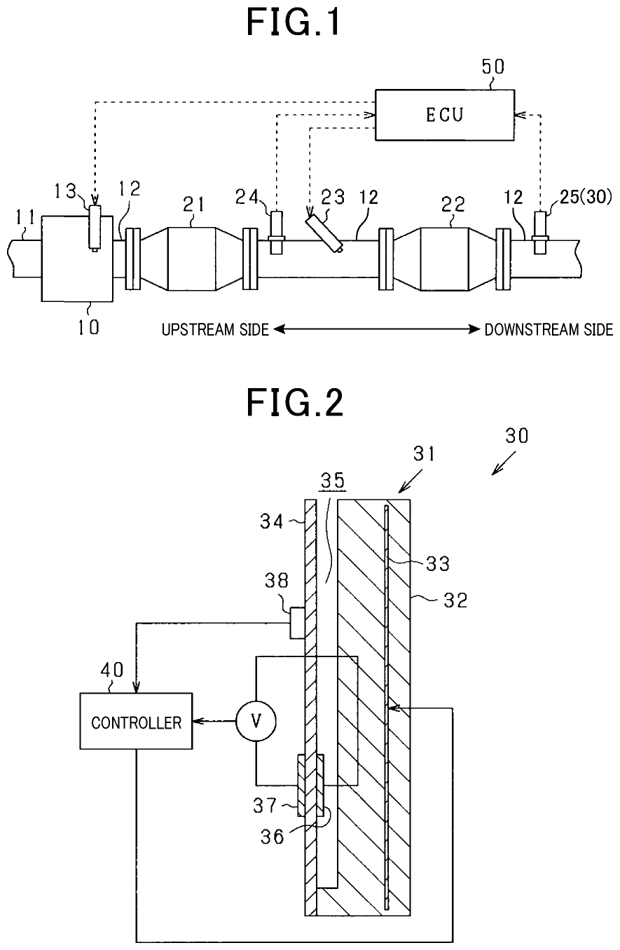

A description will be given of a gas sensor diagnosis device according to an exemplary embodiment with reference to FIG. 1 to FIG. 7. The gas sensor diagnosis device according to the exemplary embodiment is applied to an exhaust gas purification system which purifies exhaust gas emitted from an internal combustion engine such as an on-vehicle multi cylinder diesel engine, for example. It is acceptable to apply the gas sensor diagnosis device according to the exemplary embodiment to various types of engines such as a lean burn gasoline engine.

FIG. 1 is a view showing a schematic structure of the exhaust gas purification system of the internal combustion engine 10. As shown in FIG. 1, the exhaust gas purification system has an exhaust gas pipe 12, an upstream side SCR catalyst 21, a first composite sensor 24, an ammonium hydroxide supply device 23, a downstream side SCR catalyst 22, a second composite sensor 25 and an electronic control unit (ECU) 50.

FIG. 2 is a view showing a schematic structure of an ammonia sensor 30 assembled in the second composite sensor 25. The second composite sensor 25 has the ammonia sensor 30 shown in FIG. 2. The ammonia sensor 30 is equipped with a sensor element controller 40 as the gas sensor diagnosis device according to the exemplary embodiment of the present disclosure. The structure and behavior of the ammonia sensor 30 equipped with the sensor element controller 40 will be explained later in detail.

The internal combustion engine 10 is connected to an intake air passage 11 and an exhaust gas pipe 12. Outside air is introduced into each combustion chamber (not shown) in the internal combustion engine 10. Exhaust gas emitted from the internal combustion engine 10 flows in the exhaust gas pipe 12. A fuel injection device 13 is installed in the internal combustion engine 10 so as to inject a fuel into each of the combustion chambers.

As shown in FIG. 1, an upstream side selective catalyst reduction catalyst 21 (hereinafter, the upstream side SCR catalyst 21) and a downstream side selective catalyst reduction catalyst 22 (hereinafter, the downstream side SCR catalyst 22) are mounted to the exhaust gas pipe 12. The upstream side SCR catalyst 21 has an oxygen catalyst, and a diesel particulate filter (DPF). The oxygen catalyst oxidizes hydrocarbons (HC), carbon monoxide (CO), etc. contained in exhaust gas emitted from the internal combustion engine 10. The DPF collects particulate matter contained in exhaust gas.

The downstream side SCR catalyst 22 is a selective catalytic reduction catalyst which uses ammonium hydroxide (ammonium water) as a reducing agent for reducing nitrogen oxide (NOx) contained in exhaust gas. In the downstream side SCR catalyst 22, ammonia NH₃ in the ammonium hydroxide supplied from an ammonium hydroxide supply device 23 selectively reduces NOx contained in exhaust gas flowing in the exhaust gas pipe 12 located at the downstream side of the exhaust gas pipe 12 shown in FIG. 1. This makes it possible to eliminate NOx from the exhaust gas and to purify the exhaust gas. The ammonium hydroxide is stored in the downstream side SCR catalyst 22. A reduction reaction between NOx contained in exhaust gas and the stored ammonium hydroxide occurs in the downstream side SCR catalyst 22.

In the exhaust gas pipe 12, the first composite sensor 24 is arranged between the upstream side SCR catalyst 21 and the downstream side SCR catalyst 22. The first composite sensor 24 detects concentrations of NOx and oxygen in exhaust gas, and outputs detection signals corresponding to the detected nitrogen oxide and oxygen concentrations.

Further, the second composite sensor 25 is arranged at a downstream side of the downstream side SCR catalyst 22 in the exhaust gas pipe 12. The second composite sensor 25 detects a concentrations of NOx, oxygen and ammonia contained in the exhaust gas, and outputs detection signals corresponding to the detected NOx, oxygen and ammonia concentrations.

The detection results from the first and second composite sensors 24 and 25 are transmitted to the ECU 50. The second composite sensor 25 has an ammonia (NH₃) sensor 30 and a nitrogen (NOx) sensor.

The concept of the present disclosure is not limited by the structure of the exhaust gas purification system shown in FIG. 1. For example, it is acceptable to use a NOx sensor unit, an oxygen sensor unit and an ammonia sensor unit which are independently arranged in the exhaust gas pipe.

The ECU 50 is equipped with a microcomputer composed of a central processing unit (CPU), a read only memory (ROM), a random access memory (RAM), etc. The ECU 50 performs controls of adjusting an air supply amount and controls of the fuel injection device 13 on the basis of a rotation speed of the internal combustion engine 10 and a magnitude of load to the internal combustion engine 10. The ECU 50 further performs controls of the ammonium hydroxide supply device 23, etc. on the basis of the operation condition of the internal combustion engine 10, and the detection signals transmitted from the various types of the sensors such as the first composite sensor 24, the second composite sensor 25, the ammonia sensor 30, etc.

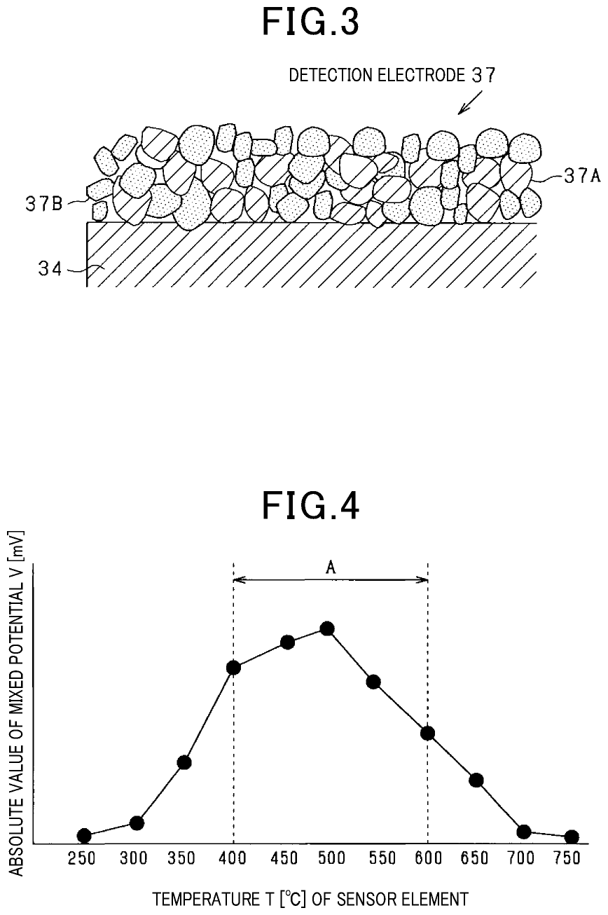

A description will be given of the ammonia sensor 30 assembled in the second composite sensor 25 with reference to FIG. 2 and FIG. 3.

As shown in FIG. 2, the ammonia sensor 30 is assembled in the second composite sensor 25 arranged at a downstream side of the downstream side SCR catalyst 22 mounted on the exhaust gas purification system shown in FIG. 1. FIG. 3 is a view showing a schematic structure of a detection electrode 37 in the ammonia sensor 30 assembled in the second composite sensor 25 shown in FIG. 1.

The ammonia sensor 30 is equipped with a sensor element 31 and the sensor element controller 40. The sensor element controller 40 performs control of the sensor element 31. That is, the sensor element controller 40 corresponds to the gas sensor diagnosis device according to the exemplary embodiment of the present disclosure.

Similar to the ECU 50, the sensor element controller 40 as the gas sensor diagnosis device is equipped with a microcomputer composed of a central processing unit (CPU), a read only memory (ROM), a random access memory (RAM), etc. The sensor element controller 40 is connected to the ECU 50. The sensor element controller 40 transmits to the ECU 50 detection signals corresponding to detection values of the ammonia sensor 30.

The sensor element 31 is a mixed potential type which is directly exposed to exhaust gas as a detection target gas and generates and provides a mixed potential. A heater 33 is formed on an insulation substrate 32 of the sensor element 31. In the structure of the sensor element 31, a solid electrolyte 34 having oxygen ion conductivity is stacked through a reference gas chamber 35. That is, the reference gas chamber 35 is formed to be sandwiched between the insulation substrate 32 and the insulation substrate 32. External air is introduced into the reference gas chamber 35. For example, the solid electrolyte 34 is made of yttria stabilized zirconia (YSZ).

A pair of electrodes are formed on opposite surfaces of the solid electrolyte 34. One of the electrodes is a reference electrode 36 which is exposed to the inside of the reference gas chamber 35. The other of the electrodes is a detection electrode 37 which is exposed to the detection target gas such as exhaust gas.

A mixture of a solid electrolyte 37A and a catalyst 37B is applied on a surface of the solid electrolyte 34 so as to form the detection electrode 37. For example, gold (Au) may be used as the catalyst 37B. It is acceptable to form a protective layer made of porous ceramic having gas permeable characteristics on the surface of the detection electrode 37 as necessary.

A thermistor 38 is arranged on the sensor element 31 so as to detect a temperature T of the sensor element 31. The concept of the present disclosure is not limited by this structure. For example, it is acceptable to detect a temperature T of the sensor element 31 on the basis of parameters which represent a correlation between a resistance value of the heater 33, a resistance value of the solid electrolyte 34, and the temperature T of the sensor element 31.

In the sensor element 31, an electrochemical reaction of ammonia and oxygen occurs on the surface of the detection electrode 37. The electrochemical reaction of ammonia and oxygen generates an electromotive force, i.e. a mixed voltage between the detection electrode 37 and the reference electrode 36. The sensor element 31 detects the mixed potential V (NH₃) and transmits a detection signal representing the mixed potential as a detection result to the sensor element controller 40 in the ammonia sensor 30.

Because there is a correlation between the mixed potential V (NH₃) and an ammonia concentration, it is possible for the sensor element controller 40 to calculate an ammonia concentration of ammonia contained in exhaust gas as the detection target gas on the basis of a correlation equation obtained by this correlation relationship which has been prepared.

The electrochemical reaction of ammonia and oxygen on the detection electrode 37 is affected by a temperature T of the sensor element 31.

FIG. 4 is a graph showing a relationship between a temperature of the sensor element 31 in the ammonia sensor 30 shown in FIG. 2 and the mixed potential V (NH₃) of the ammonia sensor 30 in the second composite sensor 25 arranged at the downstream side of the downstream side SCR catalyst 22 shown in FIG. 1.

As can be understood from FIG. 4, when the temperature T of the sensor element 31 varies in the same detection target gas, the mixed potential V (NH₃) also varies. Accordingly, the ammonia sensor 30 is used at a predetermined activation temperature which is within an activation temperature range A. In the activation temperature range A, an absolute value of the mixed potential V (NH₃) of the sensor element 31 has a large value.

In order for the sensor element 31 to reach a predetermined activation temperature, the sensor element controller 40 adjusts a power supply to the heater 33. Specifically, the sensor element controller 40 adjusts the power supply to the heater 33 so that the sensor element 31 has the predetermined activation temperature of 500° C. which is within the activation temperature range A of 400° C. to 600° C. This control allows the sensor element controller 40 to correctly calculate an ammonia concentration in the detection target gas, i.e. exhaust gas on the basis of the correlation equation between the mixed potential V (NH₃) and the ammonia concentration at the predetermined activation temperature.

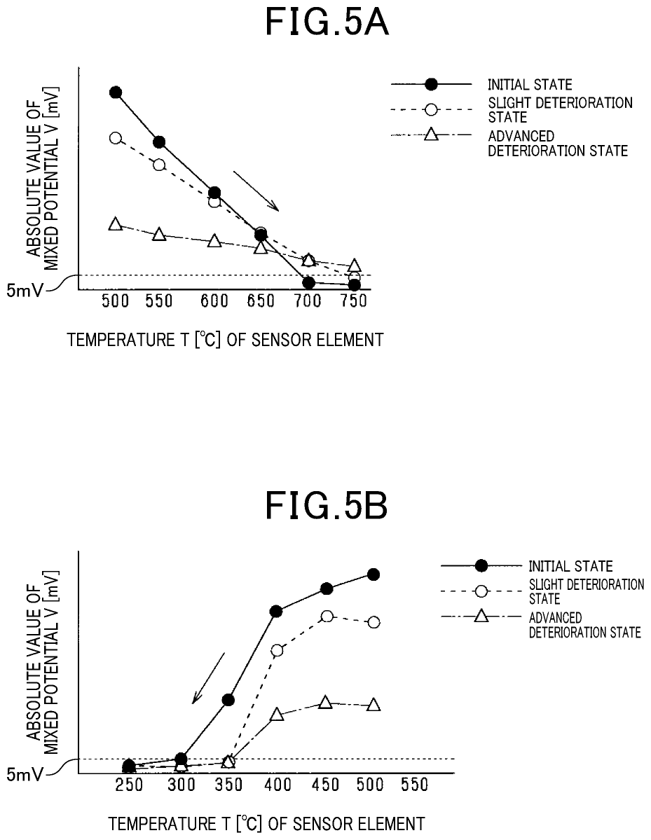

A description will be given of a zero-voltage shift phenomenon (or disappearance phenomenon) of the mixed potential V (NH₃) of the sensor element 31 with reference to FIG. 5A and FIG. 5B.

FIG. 5A and FIG. 5B are graphs showing a relationship between a temperature T and an absolute value of a mixed potential V (NH₃) of the ammonia sensor 30 in an initial state, a slight deterioration state and an advanced deterioration state thereof;

Specifically, FIG. 5A and FIG. 5B represent detection results of the mixed potential V (NH₃) of the sensor element 31 of the ammonia sensor 30 in the initial state, the slight deterioration state and the advanced deterioration state thereof when the temperature T of the sensor element 31 varies while an experimental gas (50 ppm of NH₃, 20% of O₂, and N₂ as balance) of a temperature of 250° C. is flowing at a gas flow rate of 5 L/min in the exhaust gas pipe.

That is, FIG. 5A shows a relationship between a temperature T of the sensor element 31 and an absolute value of the mixed potential V (NH₃) when the sensor element 31 is heated by the heater 33. First, the heater 31 generates thermal energy and supplies the thermal energy to the sensor element 31 at a high temperature which is higher than the predetermined activation temperature of 500° C. and outside the predetermined activation temperature range (A). This control allows the sensor element 31 to have a temperature which is higher than the activation temperature range A. After this, the electrochemical reaction at the detection electrode 37 of the sensor element 31 reaches its equilibrium state, and the mixed potential V (NH₃) thereby becomes zero, in other words, the zero-voltage shift phenomenon of the mixed potential V (NH₃) of the sensor element 31 occurs.

The inventors of the present disclosure have found the phenomenon in which the more a state of the sensor element 31 is deteriorated, the higher a necessary temperature of the sensor element 31 to reach the equilibrium state of the electrochemical state becomes. This means that the activation capability of the catalyst 37B in the detection electrode 37 is reduced.

A deteriorated sensor or a deteriorated sensor element has a zero-voltage shift temperature Tthd (a), at which the mixed potential V (NH₃) is shifted to zero or to a voltage close to zero, in other words, drops below the predetermined output threshold value. For example, the predetermined output threshold value is 5 mV which will be explained later. In other words, the mixed potential V (NH₃) disappears and becomes a zero voltage or a voltage close to zero. The zero-voltage shift temperature Tthd (a) of the deteriorated sensor becomes higher than a zero-voltage shift temperature Tthd (f) of a normal sensor which is operating correctly and normally. That is, it is possible to recognize that the zero-voltage shift temperature Tthd (a) of a deteriorated sensor, at which the mixed potential V (NH₃) becomes zero, is higher than the zero-voltage shift temperature Tthd (f) of a normal sensor.

Accordingly, it is possible for the sensor element controller 40 to perform the diagnosis operation for detecting whether the sensor element 31 is operating correctly, i.e. operating normally on the basis of the zero-voltage shift temperature Tthd of the mixed potential V (NH₃).

On the other hand, FIG. 5B shows a relationship between the mixed potential V (NH₃) and an absolute value of the mixed potential V (NH₃) of the sensor element 31 when the sensor element 31 is cooled from the predetermined activation temperature of 500° C. by turning off the heater 33.

When the sensor element controller 40 stops the heater 33 in the sensor element 31 generating thermal energy so as to cool the sensor element 31 to a temperature which is less than the activation temperature range A. This reduces the activation of the catalyst 37B of the detection electrode 37 in the sensor element 31, and increases an electrical resistance of the solid electrolyte 37A of the detection electrode 37. This causes the zero-voltage shift phenomenon of the mixed potential V (NH₃).

The inventors of the present disclosure have found the phenomenon in which the more the sensor element 31 deteriorates, the higher the zero-voltage shift temperature Tthd of the mixed potential V (NH₃) becomes. The mixed potential V (NH₃) is shifter to zero at the zero-voltage shift temperature Tthd. It can be considered that this phenomenon is caused by reduction of the activation of the catalyst 37B in the detection electrode 37.

A deteriorated sensor is lower in mixed potential V (NH₃) than a normal sensor at its initial state. The deteriorated sensor has the zero-voltage shift temperature Tthd, at which the apparent mixed potential V (NH₃) disappears or is shifted to zero, which is higher than that of the normal sensor.

That is, a deteriorated sensor becomes greater in the zero-voltage shift temperature Tthd of the mixed potential V (NH₃) than a normal sensor.

Accordingly, it is possible for the sensor element controller 40 to perform the deterioration diagnosis for detecting a deteriorated state of the sensor element 31 on the basis of the zero-voltage shift temperature Tthd of the mixed potential V (NH₃) of the sensor element 31.

A description will be given of conditions to perform the deterioration diagnosis of the sensor element 31.

When oxygen in exhaust gas has an excess concentration which is more than a normal concentration of oxygen in exhaust gas in view of a concentration of ammonia, in other words, when a concentration of oxygen in exhaust gas is not less than a predetermined high concentration, the zero-voltage shift phenomenon of the mixed potential V (NH₃) becomes noticeable.

When the internal combustion engine 10 is driven in a high air/fuel (A/F) ratio in a fuel-cut state or a lean burn state), the zero-voltage shift phenomenon of the mixed potential V (NH₃) often occurs.

In a fuel-cut state, because exhaust gas does not contain NOx, the ammonia sensor 30 is not deteriorated by NOx. That is, it is preferable to perform the deterioration diagnosis of the ammonia sensor 30 under the fuel-cut state.

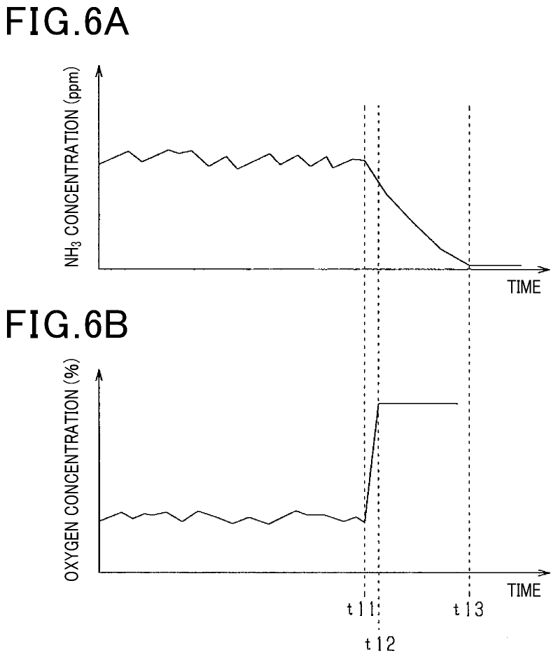

A description will now be given of a brief explanation of an oxygen concentration and an ammonia (NH₃) concentration in exhaust gas under the fuel-cut state with reference to FIG. 6A and FIG. 6B.

FIG. 6A and FIG. 6B are timing charts showing an oxygen concentration and an ammonia (NH₃) concentration in exhaust gas in the fuel-cut state.

When the fuel injection device 13 stops fuel supply, i.e. fuel injection into the internal combustion engine 10 at timing t11 shown in FIG. 6A and FIG. 6B, the ammonium hydroxide supply device 23 stops the supply of ammonium hydroxide into the exhaust gas pipe 12. Because this situation does not generate any NOx, it is preferable to stop the supply of ammonium hydroxide into exhaust gas which is flowing in the exhaust gas pipe 12.

However, when stopping the supply of ammonium hydroxide into the exhaust gas pipe 12, the remaining ammonia attached on the interior walls of the exhaust gas pipe 12 and on the interior of the downstream side SCR catalyst 22 are discharged into exhaust gas flowing in the exhaust gas pipe 12. Accordingly, a concentration of the remaining ammonia is gradually reduced and reaches to approximately zero at timing t13 with the elapse of time.

On the other hand, when the fuel injection device 13 stops the fuel supply, i.e. the fuel injection into the internal combustion engine 10, an oxygen concentration of oxygen contained in exhaust gas in the exhaust gas pipe 12 gradually approaches the oxygen concentration in atmospheric air, and the oxygen concentration reaches its equilibrium state at timing t12 shown in FIG. 6A and FIG. 6B.

This produces an oxygen excess state, or oxygen rich state, in which the oxygen concentration contained in exhaust gas becomes higher than the ammonia concentration during the period between timing t12 to timing t13. It is preferable to perform the deterioration diagnosis of the sensor element 31 in the ammonia sensor 30.

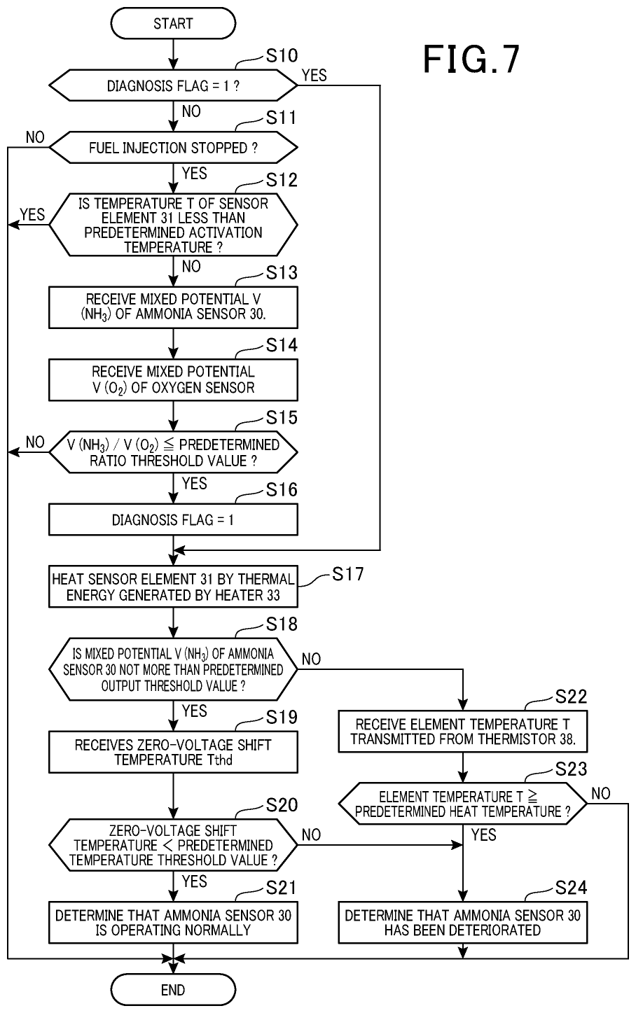

A description will now be given of the deterioration diagnosis process of the ammonia sensor 30 performed by the sensor element controller 40 in the ammonia sensor 30 with reference to FIG. 7.

FIG. 7 is a view showing a flow chart of the deterioration diagnosis process of the ammonia sensor 30 as a gas sensor performed by the gas sensor diagnosis device according to the exemplary embodiment of the present disclosure.

The sensor element controller 40 repeatedly performs the deterioration diagnosis process of the ammonia sensor 30 every predetermined period.

In step S10 shown in FIG. 7, the sensor element controller 40 detects whether a diagnosis flag has a value 1. The diagnosis flag having the value 1 represents that the sensor element controller 40 performs the deterioration process of the ammonia sensor 30. That is, when the conditions in step S11 to step S15 are satisfied, the diagnosis flag has the value 1. The value 1 of the diagnosis flag represents that the sensor element controller 40 is performing the diagnosis process.

As shown in FIG. 7, when the detection result in step S10 represents positive (“YES” in step S10), i.e. represents that the diagnosis flag has the value 1, the operation flow progresses to step S17.

On the other hand, when the detection result in step S10 represents negative (“NO” in step S10), i.e. represents that the diagnosis flag has not the value 1, the operation flow progresses to step S11.

In step S11, the sensor element controller 40 detects whether the fuel injection device 13 has stopped the fuel injection into the internal combustion engine 10 on the basis of the information transmitted from the ECU 50.

When the detection result in step S11 is negative (“NO” in step S11), i.e. indicates that the fuel injection device 13 is injecting fuel, the sensor element controller 40 finishes the deterioration diagnosis process of the ammonia sensor 30 shown in FIG. 7.

On the other hand, when the detection result in step S11 is positive (“YES” in step S11), i.e. indicates that the fuel injection device 13 has stopped the fuel injection, the operation flow progresses to step S12.

In step S12, the sensor element controller 40 detects whether the temperature T of the sensor element 31 reaches, i.e. is not less than the predetermined activation temperature within the activation temperature range A. It is difficult for the sensor element controller 40 to normally perform the deterioration diagnosis of the sensor element 31 of the ammonia sensor 30 under the condition in which the temperature T of the sensor element 31 does not reach the predetermined activation temperature.

When the detection result in step S12 is positive (“YES” in step S12), i.e. indicates that the temperature T of the sensor element 31 does not reach (is less than) the predetermined activation temperature within the activation temperature range A, the sensor element controller 40 finishes the deterioration diagnosis process of the ammonia sensor 30 shown in FIG. 7.

On the other hand, when the detection result in step S12 is negative (“NO” in step S12), i.e. indicates that the temperature T of the sensor element 31 has reached (is not less than) the predetermined activation temperature within the activation temperature range A, the operation flow progresses to step S13.

In step S13, the sensor element controller 40 receives a detection signal, transmitted from the sensor element 31, which indicates the mixed potential V (NH₃) of the ammonia sensor 30. The mixed potential V (NH₃) obtained in step S13 corresponds to the ammonia concentration. Because the NOx concentration in the exhaust gas as the detection target gas becomes approximately zero during the fuel-supply stop period, the sensor element controller 40 calculates the ammonia concentration on the basis of the detection result of the NOx sensor assembled in the second composite sensor 25. In this case, it is acceptable for the sensor element controller 40 to use this calculated ammonia concentration as the mixed potential V (NH₃) detected by and transmitted from the ammonia sensor 30.

In other words, it is possible for the sensor element controller 40 to perform the correct deterioration diagnosis process of the ammonia sensor 30 with high accuracy when using the calculated ammonia concentration and the NOx sensor which is not the deterioration state detection target. The operation flow progresses to step S14.

In step S14, the sensor element controller 40 calculates a mixed potential V (O₂) of the oxygen sensor assembled in the second composite sensor 25. The mixed potential V (O₂) corresponds to the oxygen concentration. The operation flow progresses to step S15.

In step S15, the sensor element controller 40 detects whether the oxygen concentration obtained in step S14 is in an excess state to the ammonia concentration obtained in step S13. Specifically, the sensor element controller 40 detects whether a ratio V(NH₃)/V(O₂) is not more than a predetermined ratio threshold value, where V(NH₃) is obtained in step S13, and V(O₂) is obtained in step S14.

When the detection result in step S15 is negative (“NO” in step S15), i.e. indicates that the ratio V(NH₃)/V(O₂) is more than the predetermined ratio threshold value, the sensor element controller 40 finishes the deterioration diagnosis process of the ammonia sensor 30 shown in FIG. 7.

On the other hand, when the detection result in step S15 is positive (“YES” in step S15), i.e. indicates that the ratio V(NH₃)/V(O₂) is not more than the predetermined ratio threshold value, the operation flow progresses to step S16.

In step S16, the sensor element controller 40 sets the diagnosis flag to 1. The process in step S15 performed by the sensor element controller 40 composed of the central processing unit (CPU) corresponds to the oxygen concentration detection part.

Because the ammonia concentration is represented by ppm, and the oxygen concentration is represented by percentage (%), the oxygen concentration becomes an excess state to the ammonia concentration when the oxygen concentration is not less than a predetermined oxygen concentration. Accordingly, it is acceptable for the sensor element controller 40 to detect whether the oxygen concentration is not less than the predetermined oxygen concentration in step S15, instead of using the ratio V(NH₃)/V(O₂). In the latter case, when the obtained V(O₂) is smaller than an oxygen concentration threshold value, the sensor element controller 40 finishes the deterioration diagnosis process of the ammonia sensor 30 shown in FIG. 7.

However, it is preferable for the sensor element controller 40 to perform the process of step S11 to step S16 so as to obtain the correct deterioration diagnosis process of the ammonia sensor 30 with high accuracy. The operation flow progresses to step S17.

In step S17, the sensor element controller 40 instructs the heater 33 to generate thermal energy. This increases a temperature of the sensor element 31. That is, the sensor element controller 40 instructs the heater 31 to take the temperature T of the sensor element 31 outside of the activation temperature range A. Because increasing of the temperature of the sensor element 31 allows gas, except ammonia, which is strongly adsorbed on the surface of the sensor element 31, to be desorbed from the surface of the sensor element 31, this makes it possible to suppress gases adsorbed on the surface of the sensor element 31 from influencing the correct deterioration diagnosis of the ammonia sensor 30.

The heating control of the heater 33 makes it possible to easily adjust the temperature T of the sensor element 31 in the ammonia sensor 30. The process in step S17 performed by the sensor element controller 40 composed of the central processing unit (CPU) corresponds to the temperature change part. The operation flow progresses to step S18.

In step S18, the sensor element controller 40 detects whether the mixed potential V (NH₃) of the ammonia sensor 30 has become zero, in more detail, is not more than a predetermined output threshold value, i.e. disappears. Specifically, the sensor element controller 40 receives a detection signal regarding the mixed potential V(NH₃), and detects whether the mixed potential V(NH₃) is not more than the predetermined output threshold value.

The predetermined output threshold value is substantially zero, at which the mixed potential V (NH₃) disappears, i.e. is shifted to zero or a small value close to zero. For example, it is possible for the sensor element controller 40 to use the value of 5 mV as the predetermined output threshold value. The process in step S18 performed by the sensor element controller 40 composed of the central processing unit (CPU) corresponds to the zero-voltage shift detection part.

When the detection result in step S18 is positive (“YES” in step S18), i.e. indicates that the mixed potential V(NH₃) is not more than a predetermined output threshold value, the operation flow progresses to step S19.

In step S19, the sensor element controller 40 receives a detection signal regarding a zero-voltage shift temperature Tthd at which the mixed potential V (NH₃) is shifted to zero or substantially shifted to zero. Specifically, the sensor element controller 40 receives the detection signal regarding the zero-voltage shift temperature Tthd transmitted from the thermistor 38 when the mixed potential V (NH₃) is shifted to zero or to a voltage close to zero, i.e. is not more than the predetermined output threshold value. For example, the predetermined output threshold value is 5 mV as previously described. The process in step S19 performed by the sensor element controller 40 composed of the central processing unit (CPU) corresponds to the temperature acquisition part. The operation flow progresses to step S20.

In step S20, the sensor element controller 40 detects whether the zero-voltage shift temperature Tthd obtained in step S19 is less than a predetermined temperature threshold value. It is acceptable for the sensor element controller 40 to use a value, as the predetermined temperature threshold value, obtained by adding an initial temperature threshold value Tthd0 at which the initial mixed potential V (NH₃) is shifted to zero with an allowable value. For example, it is acceptable to use a value of Tthd0+20° C. or a predetermined constant temperature value.

When the detection result in step S20 is positive (“YES” in step S20), i.e. indicates that the zero-voltage shift temperature Tthd obtained in step S19 is less than a predetermined temperature threshold value, the operation flow progresses to step S21.

In step S21, the sensor element controller 40 determines that the ammonia sensor 30 is operating normally (normal sensor). The sensor element controller 40 finishes the deterioration diagnosis process of the ammonia sensor 30 shown in FIG. 7.

On the other hand, when the detection result in step S20 is negative (“NO” in step S20), i.e. indicates that the zero-voltage shift temperature Tthd obtained in step S19 is not less than a predetermined temperature threshold value, the operation flow progresses to step S24.

In step S24, the sensor element controller 40 determines that the ammonia sensor 30 is not operating correctly, i.e. has been deteriorated (failed sensor). The sensor element controller 40 finishes the deterioration diagnosis process of the ammonia sensor 30 shown in FIG. 7.

When the detection result in step S20 is negative (“NO” in step S20), i.e. indicates that the zero-voltage shift temperature Tthd obtained in step S19 is not less than a predetermined temperature threshold value, the sensor element controller 40 corrects the output of the ammonia sensor 30 on the basis of a predetermined correction map according to the magnitude of the deteriorated state of the ammonia sensor 30. It is also acceptable for the sensor element controller 40 to provide warning regarding the deterioration state of the ammonia sensor 30.

The process in step S20 performed by the sensor element controller 40 composed of the central processing unit (CPU) corresponds to the deterioration state detection part.

When the detection result in step S18 is negative (“NO” in step S18), i.e. indicates that the mixed potential V(NH₃) is more than a predetermined output threshold value, and the mixed potential V(NH₃) does not shifted to zero, the operation flow progresses to step S22.

In step S22, the sensor element controller 40 receives a detection signal representing an element temperature T transmitted from the thermistor 38. The operation flow progresses to step S23.

In step S23, the sensor element controller 40 detects whether the received element temperature T is not less than a predetermined temperature. The sensor element controller 40 determines the predetermined temperature which is more than the zero-voltage shift temperature Tthd of the mixed potential V (NH₃) of the sensor element 31 in an ammonia sensor 30 which is operating normally in its initial state so as to suppress thermal deterioration of the sensor element 31. For example, it is acceptable for the sensor element controller 40 to determine the predetermined temperature of 800° C.

When the detection result in step S23 is negative (“NO” in step S23), i.e. indicates that the received element temperature T is less than (i.e. does not reach) the predetermined temperature, the sensor element controller 40 finishes the deterioration diagnosis process of the ammonia sensor 30 shown in FIG. 7.

On the other hand, when the detection result in step S23 is positive (“YES” in step S23), i.e. indicates that the received element temperature T is not less than the predetermined temperature, the operation flow progresses to step S24.

In step S24 the sensor element controller 40 determines that the ammonia sensor 30 is not operating normally, i.e. is a deteriorated sensor or a failed sensor. The sensor element controller 40 finishes the deterioration diagnosis process of the ammonia sensor 30 shown in FIG. 7.

A description will now be given of effects of the sensor element controller 40 as the gas sensor diagnosis device according to the exemplary embodiment.

In the gas sensor diagnosis device according to the exemplary embodiment, a temperature of the sensor element 31 in the ammonia sensor 30 is shifted outside of the activation temperature range A so as to shift the mixed potential V (NH₃) of the sensor element 31 in the ammonia sensor 30 to zero or to a substantially zero value.

The sensor element controller 40 detects and obtains the zero-voltage shift temperature Tthd when the mixed potential V (NH₃) of the sensor element 31 is shifted to zero. The sensor element controller 40 detects whether the sensor element 31 has been deteriorated on the basis of the zero-voltage shift temperature Tthd.

Accordingly, it is possible to easily detect the deterioration state of the sensor element 31 of the ammonia sensor 30 on the basis of a simple structure of the sensor element controller 40 for changing a temperature of the sensor element 31, detecting a temperature of the sensor element 31 and obtaining the mixed potential V(NH₃) of the sensor element 31.

The sensor element controller 40 detects the time when the mixed potential V (NH₃) is shifted to zero or a voltage close to zero, i.e. disappears on the basis of heating the heater 33 in the sensor element 31.

The use of thermal energy generated by the heater 33 allows the sensor element controller 40 to easily perform the temperature control of the sensor element 31. Further, this control of the sensor element controller 40 makes it possible to desorb gas molecules, excepting detection target gas molecules which have been adsorbed on the surface of the sensor element 31, from the surface of the sensor element 31. That is, it is possible for the sensor element controller 40 as the gas sensor diagnosis device according to the exemplary embodiment to perform the diagnosis such as deterioration diagnosis of the ammonia sensor 30 with high accuracy.

Excess heating of the sensor element 31 promotes deterioration of the sensor element 31. Setting of an upper limit value of heating prevents thermal deterioration of the sensor element 31 from occurring. Accordingly, it is possible to maintain a necessary temperature to perform the deterioration diagnosis process of the sensor element 31 in the ammonia sensor 30 by heating the sensor element 31 to a temperature which is higher than the zero-voltage shift temperature Tthd of the mixed potential V (NH₃) of the normal sensor element 31 which is operating normally.

Further, when the mixed potential V (NH₃) cannot be shifted to zero at the upper limit temperature, it is possible for the sensor element controller 40 to determine that the ammonia sensor 30 has been deteriorated as a failed sensor. In this deterioration state of the ammonia sensor 30, the more the zero-voltage shift temperature Tthd of a sensor becomes higher than the zero-voltage shift temperature Tthd of a normal sensor which is operating normally, the more the deterioration of the sensor becomes progressed.

The zero-voltage shift phenomenon, in which the mixed potential V (NH₃) is shifted to zero, remarkably occurs in a case in which an oxygen concentration in exhaust gas as the detection target gas is adequately high, which is not less than the predetermined higher oxygen concentration, which is also higher than an ammonia concentration in exhaust gas as the detection target gas. Accordingly, it is possible for the sensor element controller 40 to normally detect a deterioration state of the ammonia sensor 30 in the state of the predetermined oxygen concentration.

When using a selective catalyst reduction catalyst so as to reduce NOx contained in exhaust gas, the ammonia sensor 30 is arranged in the exhaust gas pipe 12 connected to the internal combustion engine 10 shown in FIG. 1. During a period in which the fuel injection device 13 does not inject any fuel into the internal combustion engine 10, for example, during a fuel-cut state, the internal combustion engine 10 emits atmospheric air only, which has been introduced into the internal combustion engine 10, into the exhaust gas pipe 12. In this situation, the oxygen concentration in the exhaust gas becomes high. In this situation, because the oxygen concentration becomes high, it is possible for the sensor element controller 40 to detect the deterioration state of the ammonia sensor 30 with high accuracy.

The concept of the present disclosure is not limited by the exemplary embodiment previously described. For example, it is acceptable to have various modifications as follows.

In the deterioration diagnosis process of the ammonia sensor 30 shown in FIG. 7, the mixed potential V (NH₃) is shifted to zero by heating the sensor element 31 of the ammonia sensor 30. However, the concept of the present disclosure is not limited by this exemplary embodiment. It is acceptable for the sensor element controller 40 to cool the sensor element 31 to a temperature outside the activation temperature range A so as to shift the mixed potential V (NH₃) to zero. Specifically, in step S17, the sensor element controller 40 stops the power supply to the heater 33 so as to stop the heater 33 generating thermal energy, and to cool the sensor element 21 by using exhaust gas. In this case, it is preferable for the fuel injection device 13 to stop the fuel supply into the internal combustion engine 10 because exhaust gas of a low temperature is flowing.

In step S18 after step S17, when detecting that the mixed potential V (NH₃) is more than the predetermined output threshold value, i.e., is not shifted to zero or a value close to zero by the cooling process, the sensor element controller 40 finishes the deterioration diagnosis process of the ammonia sensor 30 shown in FIG. 7.

On the other hand, when the detection result in step S18 indicates that the mixed potential V (NH₃) has been shifted to zero or to a voltage close to zero, the operation flow progresses to step S19. For example, the voltage close to zero is 5 mV, as previously described.

In step S19, the sensor element controller 40 acquires the zero-voltage shift temperature Tthd. In step S20, the sensor element controller 40 detects whether the acquired zero-voltage shift temperature Tthd is less than, or not less than the predetermined temperature threshold value.

As previously described, a deteriorated sensor element, i.e. a failed sensor element is higher in the zero-voltage shift temperature Tthd becomes higher than a normal sensor element which is operating normally when the mixed potential V (NH₃) is shifted to zero or to a voltage (for example, 5 mV) close to zero at a low temperature which is lower than the activation temperature range A. In this case, when the sensor element controller 40 detects that the zero-voltage shift temperature Tthd is less than the predetermined temperature threshold value in step S19, the operation flow progresses to step S24. In step S24, the sensor element controller 40 determines that the ammonia sensor 30 is not operating normally, i.e. is a deteriorated sensor or a failed sensor. After this, the sensor element controller 40 finishes the deterioration diagnosis process of the ammonia sensor 30 shown in FIG. 7.

As previously described, it is possible for the sensor element controller 40 to cool the sensor element 31 so as to shift the mixed potential V (NH₃) to be not more than the predetermined output threshold value close to zero, and to detect the occurrence of deterioration of the sensor element 31 of the ammonia sensor 30.

It is possible to apply the concept of the present disclosure to various sensors such as a mixed potential type gas sensor such as NOx sensor, etc. to detect another gas, in addition to the ammonia sensor 30.

In the exemplary embodiment previously described, the sensor element controller 40 performs the control of the sensor element 31, and the deterioration detection of the sensor element 31. However, the concept of the present disclosure is not limited by this exemplary embodiment. It is acceptable for the ECU 50 to perform the control of the sensor element 31 and the deterioration detection of the sensor element 31 when the ammonia sensor 30 does not have the sensor element controller 40.

While specific embodiments of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present disclosure which is to be given the full breadth of the following claims and all equivalents thereof.

What is claimed is:

1. A gas sensor diagnosis device for a gas sensor of a mixed potential type, the gas sensor comprising a sensor element arranged to be exposed to a detection target gas, the sensor element generating and transmitting a mixed potential to the gas sensor diagnosis device when the sensor element is heated at an activation temperature within a predetermined activation temperature range,
the gas sensor diagnosis device comprising a central processing unit being configured to provide:
a temperature change part which varies a temperature of the sensor element to a first temperature which is outside of the predetermined activation temperature range;
a zero-voltage shift detection part which detects whether the mixed potential of the sensor element is not more than a predetermined output threshold value of the sensor element after the temperature change part varies the temperature of the sensor element;
a temperature acquisition part which detects a zero-voltage shift temperature of the sensor element at which the zero-voltage shift detection part detects that the mixed potential of the sensor element is shifted to not more than the predetermined output threshold value; and
a deterioration state detection part which detects whether the sensor element has been deteriorated on the basis of the zero-voltage shift temperature of the sensor element detected by the temperature acquisition part.

2. The gas sensor diagnosis device for a gas sensor according to claim 1, wherein
the gas sensor further comprises a heater which generates thermal energy to heat the sensor element, and
the temperature change part controls the heater so as to increase a temperature of the sensor element to the first temperature at which the zero-voltage shift detection part detects a zero-voltage shift phenomenon in which the mixed potential of the sensor element is not more than the predetermined output threshold value.

3. The gas sensor diagnosis device for a gas sensor according to claim 2, wherein
the temperature change part instructs the heater to generate thermal energy to heat the sensor element at the first temperature, the first temperature being higher than a zero-voltage shift temperature of a normal sensor element during normal operation, detected when a mixed potential of the normal sensor element is not more than the predetermined output threshold value, and
the deterioration state detection part detects that the sensor element has been deteriorated when the mixed potential of the sensor element is maintained at more than the predetermined output threshold value during the heating of the sensor element at the first temperature.

4. The gas sensor diagnosis device for a gas sensor according to claim 1, wherein
the gas sensor diagnosis device detects a deterioration state of an ammonia sensor as the gas sensor,
the gas sensor diagnosis device further comprises an oxygen concentration detection part which detects whether an oxygen concentration in the detection target gas is not less than a predetermined oxygen concentration, and
the deterioration state detection part detects whether the sensor element has been deteriorated when the oxygen concentration detection part detects that an oxygen concentration in the detection target gas is not less than the predetermined oxygen concentration.

5. The gas sensor diagnosis device for a gas sensor according to claim 2, wherein
the gas sensor diagnosis device detects a deterioration state of an ammonia sensor as the gas sensor,
the gas sensor diagnosis device further comprises an oxygen concentration detection part which detects whether an oxygen concentration in the detection target gas is not less than a predetermined oxygen concentration, and
the deterioration state detection part detects whether the sensor element has been deteriorated when the oxygen concentration detection part detects that an oxygen concentration in the detection target gas is not less than the predetermined oxygen concentration.

6. The gas sensor diagnosis device for a gas sensor according to claim 3, wherein
the gas sensor diagnosis device detects a deterioration state of an ammonia sensor as the gas sensor,
the gas sensor diagnosis device further comprises an oxygen concentration detection part which detects whether an oxygen concentration in the detection target gas is not less than a predetermined oxygen concentration, and
the deterioration state detection part detects whether the sensor element has been deteriorated when the oxygen concentration detection part detects that an oxygen concentration in the detection target gas is not less than the predetermined oxygen concentration.

7. The gas sensor diagnosis device for a gas sensor according to claim 1, wherein
the deterioration state detection part detects a deterioration state of the sensor element during a period in which no fuel is supplied into the internal combustion engine when the gas sensor is an ammonia sensor arranged in an exhaust gas pipe connected to an internal combustion engine, and a selective catalyst reduction catalyst is arranged in the exhaust gas pipe and uses ammonia to reduce nitrogen oxide contained in exhaust gas.

8. The gas sensor diagnosis device for a gas sensor according to claim 2, wherein
the deterioration state detection part detects a deterioration state of the sensor element during a period in which no fuel is supplied into the internal combustion engine when the gas sensor is an ammonia sensor arranged in an exhaust gas pipe connected to an internal combustion engine, and a selective catalyst reduction catalyst is arranged in the exhaust gas pipe and uses ammonia to reduce nitrogen oxide contained in exhaust gas.

9. The gas sensor diagnosis device for a gas sensor according to claim 3, wherein
the deterioration state detection part detects a deterioration state of the sensor element during a period in which no fuel is supplied into the internal combustion engine when the gas sensor is an ammonia sensor arranged in an exhaust gas pipe connected to an internal combustion engine, and a selective catalyst reduction catalyst is arranged in the exhaust gas pipe and uses ammonia to reduce nitrogen oxide contained in exhaust gas.
